(19) United States
(12) Patent Application Publication
(10) Pub. No.: US 2005/0091975 A1
(43) Pub. Date: May 5, 2005

(54) Microactivation using fiber optic and wireless means

(75) Inventor: Ken Clements, Los Gatos, CA (US)

Correspondence Address: BASCH & NICKERSON LLP, 1777 PENFIELD ROAD, PENFIELD, NY, 14526, US

(73) Assignee: Technology Innovations, LLC, West Henrietta, NY (US)

(21) Appl. No.: 10/988,379

(22) Filed: Nov. 12, 2004

Related U.S. Application Data
(63) Continuation-in-part of application No. 10/449,351, filed on May 30, 2003.
Application No. 10/449,351 is a continuation-in-part of application No. 10/058,887, filed on Jan. 28, 2002, now Pat. No. 6,588,208.
(60) Provisional application No. 60/519,917, filed on Nov. 14, 2003.

(51) Int. Cl. F02G 1/04; F01B 29/10

(52) U.S. Cl. 60/527

(57) ABSTRACT

Disclosed is the operation of actuators, and particularly microactuators, by the application of energy other than through conventional sources of heating, including fiber optics for both control/feedback and energy delivery.

This application claims priority from U.S. Provisional Application 60/519,917, filed Nov. 14, 2003 for an Improved Technique for Microactivation, by K. Clements and M. Weiner. This application is a Continuation-In-Part of co-pending U.S. patent application Ser. No. 10/449,351 by K. Clements, filed May 30, 2003 for a “Wireless Technique for Microactivation,” which is a continuation of U.S. U.S. patent application Ser. No. 10/058,887 by K. Clements, now U.S. Pat. No. 6,588,208, issued Jul. 8, 2003, for a “Wireless Technique for Microactivation,” the contents of the above-identified applications and patents being hereby incorporated by reference in their entirety.

### BACKGROUND AND SUMMARY

The following related publications are also hereby incorporated by reference for their teachings:

K. Eric Drexler, Engines of Creation: the coming era of nanotechnology, Anchor Doubleday, 1986;

K. Eric Drexler, Nanosystems, Molecular Machinery, Manufacturing, and Computation, John Wiley & Sons, Inc., 1992;

James R. von Ehr, Zyvex “the first nanotechnology development company”, http://www.zyvex.com;

MF Yu, M. J. Dyer, G. D. Skidmore, H. W. Rohrs, X K Lu, K. D. Ausman, J. R. Von Ehr, R. S. Ruoff, 3 Dimensional Manipulation of Carbon Nanotubes under a Scanning Electron Microscope, Sixth Foresight Conference 1998;

A. D. Johnson, “Vacuum-Deposited TiNi Shape memory Film: Characterization and Applications in Micro-Devices,” J. Micromech. Microeng. 1(1991) 34-41;

P. Krulevitch, A. P. Lee, P. B. Ramsey, J. C. Trevino, J. Hamilton, M. A. Northrup, “Thin film Shape Memory Alloy Microactuators, J. MEMS, vol. 5, No. 4, December 1996 (showing that SMA has the highest work output per unit volume of any actuating technology); and

Deepak Srivastava, NASA Ames research Center, Moffett Field, 650 604 3468 deepak@nasa.gov; private communication to Vikas Galhotra at TiNi Alloy Company.

In 1982 K. Eric Drexler introduced the idea of assemblers of molecular size in his book “Engines of Creation” (cited above). Nanotechnology is the subject of at least one international conference, and one commercial venture has been organized and funded to invest research and planning in this technology. Although commercial realization of nanotechnology may be years away, there is strong indication that research following the human genome project, and particularly the study of protein structure and function, will require tools to manipulate components of the cell. Development of these tools is a demanding, exciting, and challenging research subject.

Miniaturization of mechanical devices is evolving toward nanometer scale, requiring handling and assembly of objects as small as a few nanometers. Manipulation of samples and specimens smaller than a few microns in size demands a technology that, at present, does not exist. Assemblers are needed that can grip collections of molecules, releasing them from their present location, lifting, rotating, and forcefully placing them in a new environment.

Existing micropositioners do not provide the requisite flexibility of motion for assembly tasks that are contemplated. Forceful shape memory alloy actuators can be scaled to micron size. These devices are thermally powered and so require a source of heat energy: this heat may be supplied by conduction, joule heating, infrared light, or other means. The present invention contemplates the use of a scanning electron microscope beam to provide heat energy to energize thermal actuators. Prototype actuators are fabricated by sputter deposition of titanium-nickel thin film, photolithographic patterning, and chemical milling. A scanning electron or photonic beam is positioned to produce local heating, and to observe the resulting motion.

Atomic force microscopy can be used to move individual atoms but not to grip larger objects with enough force to hold against local forces. In recent investigations of the properties of carbon nanotubes, piezoelectric stepper motors have been used to manipulate structures orders of magnitude smaller than the drivers (see MF Yu et al. in “3 Dimensional Manipulation of Carbon Nanotubes under a Scanning Electron Microscope”). Manipulation of objects this small would be improved if the end-effectors were not much larger than the objects they control. In analogy to the shoulder-wrist-finger arrangement of the human hand, gross positioning should be managed by actuators of macroscopic size, and fine control by end-effectors of much smaller size.

The force of actuation should be produced as close as possible to the point of application. This implies that manipulation of sub-micron size objects requires micron-size actuators. Conventional actuators (electromagnetic, piezoelectric) do not scale well to micron size. A promising form of actuation is heat-actuated devices, particularly shape memory actuators. Photolithography provides means of fabricating devices of sub-micron size. Miniature shape memory alloy (SMA) actuators rely on joule heating to cause the phase change. In the sub-micron range it is difficult to make electrical connection, especially on devices that move. To solve this problem, the present invention focuses on the actuation of sub-micron scale shape memory alloy devices by electron-beam excitation.

The present invention is directed to the operation of actuators, and particularly microactuators, by the application of energy other than through conventional sources of heating such as resistive heating and the like. Whereas microactuators now require wires or tubes attached to get the energy and control signals down to them, this invention discloses a wireless technique for both control and energy, as well as the return path for observation and data.

Current devices are fabricated as small as a few hundred microns using conventional microlithography. Shrinking this technology to sub-micron dimensions has raised at least two questions. Will the shape memory property be preserved when the dimensions are as small or smaller than the crystal domains? And, how can such small objects (sub-micron) be selectively heated to produce actuation? The present invention, based upon research conducted to answer such questions, provides preliminary proof-of-concept.

In accordance with an aspect of the present disclosure, there is provided a method for driving a nano-sized actuator, including the steps of: pre-straining a nano-sized shape memory alloy in a low-temperature state to produce the actuator; and subsequently heating, at least a portion of the actuator, above a phase transformation temperature to cause a change in shape of the actuator.

In accordance with another aspect of the present disclosure, there is provided an apparatus for driving a shape memory alloy actuator, including: a shape memory alloy actuator having at least one protrusion extending therefrom; means for pre-straining shape memory actuator, by displacing the protrusion in a low-temperature state to form a first shape; and means for directing photonic energy at a region of the shape memory actuator and thereby causing the temperature to rise above a phase transformation temperature, such that the shape of the shape memory actuator is altered from its first shape.

In accordance with a further aspect of the present disclosure, there is provided an actuator apparatus, including: a thermally-activated actuator having at least one protrusion extending therefrom; means for pre-straining the actuator by displacing the protrusion in a low-temperature state; and means for applying photonic energy at a region near the protrusion, for heating the actuator and thereby causing the temperature to rise above a phase transformation temperature such that the actuator changes shape.

One aspect of the invention is based on the discovery of techniques for achieving high work output per unit volume in micro-robotic actuators, and in particular TiNi and similar actuators. Such actuators are attractive as a means of powering nano-robotic movement, and are suitable for manipulation of structures at or near the molecular scale. In these very small devices (one micron scale), one means of delivery of energy is by electron beams. Movement of mechanical structures a few microns in extent has been demonstrated in a scanning electron microscope. Results of these and subsequent experiments will be described, with a description of potential structures for fabricating moving a microscopic x-y stage.

### BRIEF DESCRIPTION OF THE DRAWINGS

FIG. 1 is a graph of resistivity versus temperature for an exemplary TiNi film sputter-deposited on silicon oxide in accordance with an aspect of the present invention;

FIG. 2 is a scanning electron beam image of TiNi film with fenestrations;

FIG. 3 is a heated sample holder for a scanning electron microscope in accordance with an aspect of the present invention;

FIGS. 4A-4C are a sequence of images from the SEM showing the results of heating the TiNi specimen by SEM electron beam;

FIGS. 5A and 5B are illustrative schematics of a single-direction platform moved by microactuators in accordance with an aspect of the present invention; and

FIGS. 6A, 6B and 6C are illustrative examples of alternative means for delivering energy to actuators in order to activate the shape memory actuator.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. As used herein the term “non-linear” is intended for use in characterizing the path of the energy source as one that is other than a straight line.

As depicted by information in the associated figures, the present invention is directed to the operation of microactuators by focused beam energy. The microactuators are of a microscopic and/or nanoscopic size, thereby allowing for the application of movement on a very small scale. As will be appreciated such devices have particular application in various embodiments, including but not limited to, molecular (i.e. nanoscale) linear and rotational motors, switches and the like. As actuators, the shape memory alloys and materials exhibiting similar characteristics, can be employed in various shapes to perform switching or similar mechanical movements—whether to act on another element (e.g., bi-modal switch), to energize rotating elements, etc. For example, such devices may provide on-chip switching capabilities such as may be adapted for RF chips.

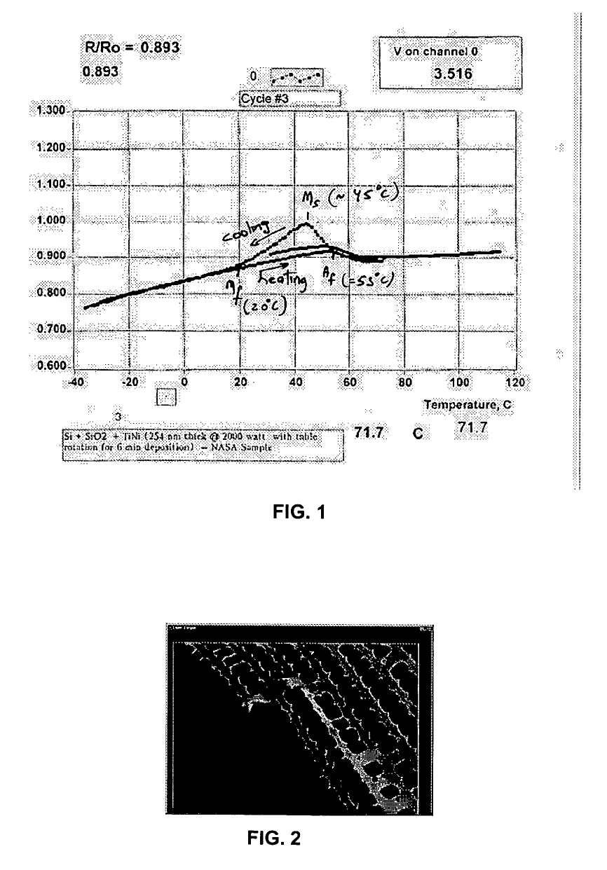

As depicted in the graph of FIG. 1, memory property may be preserved when the dimensions of a device are as small as, or smaller than, the crystal domains. For example, a film approximately 100 nanometers (nm) (about 200 atomic layers) thick was shown to undergo a phase transformation as indicated by a change in resistivity. The change in slope and hysteresis loop are typical for TiNi shape memory alloy (SMA).

As noted herein, a scanning electron microscope electron beam (e-beam) may be used to provide the heat energy, and beam steering can bring a spot of energy a fraction of a micron in diameter to bear on a sample. Therefore, the questions of how much power must be delivered to the sample, and whether the beam can provide this much energy in a short enough time to effect a shape change were addressed.

The estimated energy required to actuate a TiNi specimen 4×10×100 microns by heating it from the room temperature to the transition point is about 1.3×10 −5 joules (DT=˜80 C, DH=˜25 J/gm, Cp=˜0.3 J/gm ° C., density=6.4 gm/cm3). The power available from the electron beam is 2×10−3 watt (for accelerating voltage ˜20 KV and beam current ˜10−7 A) and the estimated heating time is ˜6×10−3 sec.

Demonstration of shape recovery requires that the specimen be pre-strained (stretched, compressed, or bent) while it is in its low-temperature state and then heated above the phase transformation temperature. The sample used was a fragment of TiNi film 4 micrometers thick deposited on silicon oxide, and patterned with fenestrations about 40 microns in diameter, and removed from the substrate. This film was further etched to diminish the width and thickness of the web elements. The resulting web was torn apart, producing small protrusions about 1-2 micron wide and 20 microns long. Referring to FIG. 2, one such structure is depicted in the micrograph. Some of these were bent during tearing, others were deformed manually using a micromanipulator.

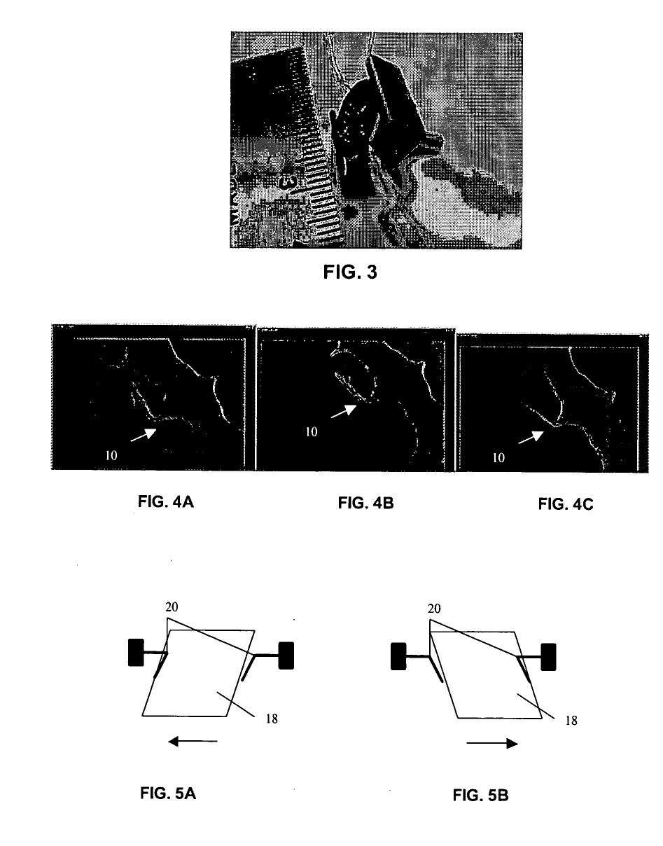

Once the structures were isolated, the specimen was placed on a heated pedestal in an ISI-SS60 scanning electron microscope. The pedestal was equipped with a heater and thermocouple so that the base temperature of the structure could be controlled and measured. An exemplary fixture is depicted in FIG. 3 against a size reference. Fluke instruments were used to record temperature and current through the heater, and an IRF 640 field-effect transistor, with a variable gate voltage, was used to control the current through the heater to vary the temperature of the substrate.

Subsequently, the chamber was evacuated and the e-beam was started. A picture was obtained at 1.5 kx magnification. The sample holder was heated with resistance heater to a temperature above ambient of approximately 40° C. and approximately 10° C. below the transition temperature around 45-50° C. of the TiNi. This was to enable the electron beam to bring the temperature through a relatively small temperature change to effect the phase transformation. The beam was centered approximately on the bent portion of the microbeam as indicated by reference arrow 10. It should be further appreciated that the amount of pre-heating energy applied influences the amount of power that must be applied by the focused beam—the lower the pre-heat temperature of the shape memory alloy, the more energy that must be applied by the beam.

The SEM beam aperture was opened to impart the maximum current to the specimen, using spot mode, and current in the e-beam was increased. Typical current used was in the range of 70 to 100 nano-amperes measured with a Kiethley picoammeter connected between the sample and ground potential. This current was applied to the sample for a time between 2 and 10 seconds, although other exposure times may be suitable. After exposure, the beam current was reduced and further pictures taken.

The resultant movement of the structure are shown in FIGS. 4A through 4C. In particular, image FIG. 4A shows the sample previous to heating. Images 4B and 4C, in turn, show the progressive actuation as successive parts of the device were heated by the electron beam. Approximately thirty degrees of recovery was achieved, although other levels may be possible depending upon the structure characteristics. Accordingly, the lever achieved in the experimental design is about 2 microns in diameter and 20 microns long.

As a result of the initial experiments, the micro-cantilever moving about thirty degrees from its original position was not due to thermal expansion as it did not reverse when the temperature was reduced. Thus, actuation of a micro-scale device by scanning electron beam was demonstrated, showing that the e-beam can provide enough energy to cause the phase transformation (and resultant movement) under controlled conditions.

Using such information, the present invention is directed toward a number of alternative embodiments. One such embodiment, depicted in FIGS. 5A and 5B, contemplates construction of a platform 18 and providing molecular and nano-level x-y motion using pairs of opposed bending cantilevers 20, so that partial actuation of one cantilever pushes the platform in the direction of the arrow while pre-straining the opposing cantilever. Similarly, it is believed that larger-scale, translational motion can be achieved with multiple actuators operating in sequence against a ratcheting or similar advancement mechanism.

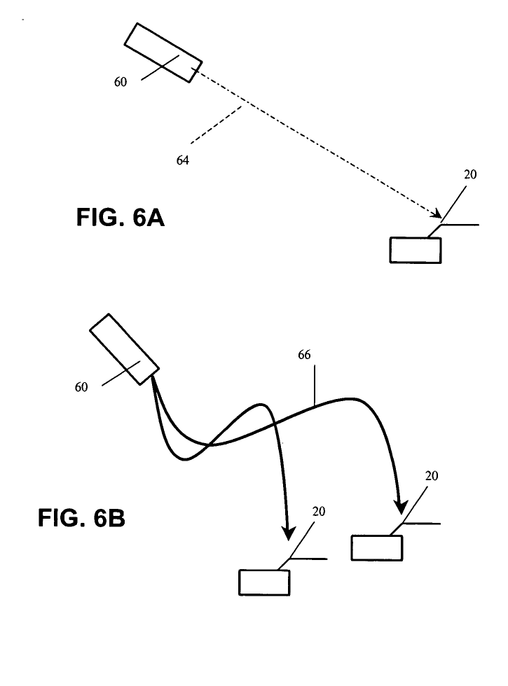

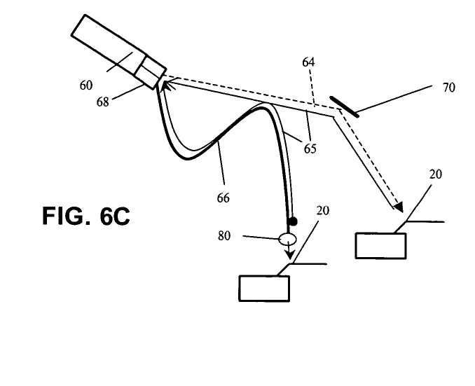

In the electron microscope embodiment described herein, it is further contemplated as part of the invention, that the normal beam is used for both causing and observing movement of the memory alloy segment or structure. Moreover, a software or similar feedback loop may be implemented, perhaps providing wireless control of microrobotic systems. Analogous actions can be done in the optical and ultrasonic embodiments described below. As further depicted in FIG. 6C, the present invention also contemplates that use of the energy delivery means, and path, as an element of the feedback loop. More specifically, with brief reference to FIG. 6C, the photonic path may also be used as a means by which the condition of the actuator is observed (return path 65) and which may include various optical sensors and processing circuitry as will be appreciated in the art. It is also contemplated that the system may employ simple SMA state sensors that indicate one of two positions as a result of the optical feedback. For example, the actuator itself may provide a detectible reflection of the photonic energy when in its first position and a different reflection point when in a second position. Thus, by monitoring the reflection, the position of the actuator may be detected and fed back to a feedback-control apparatus wherein the applied energy can be turned off once the alteration in the actuator's shape or position is detected.

In an alternative to the e-beam embodiment described above, it is also contemplated that aspects of the present invention may be implemented using laser energy in an optical microscope. It will be appreciated by those skilled in the art that the concept is the same in both cases; a beam of energy focused on a shaped memory alloy segment will produce local heating of the segment, giving rise to movement.

In yet another alternative embodiment, the present invention may employ various alternative sources for generating, and media for transferring, energy to the actuator thereby causing the requisite heating. For example, as depicted in FIG. 6A, energy may be directed from a source (e.g., photon, laser, etc.) and aimed at the actuator flex point, or similar portion thereof using wireless techniques such as a beam 64, including infrared wavelengths of light. However, it is also contemplated that the energy from source 60 may be delivered via a fixed or flexible conduit such as a fiber 66 or similar photonic energy conductor. In such an embodiment, as illustrated in FIG. 6B, the conduit may be added to or embedded within the structure to which the actuator is attached or formed. In other words, the conduit for the transport of the photonic or similar energy may be embedded within the structure in which the actuator is formed. As will be appreciated the direct beam and flexible conduit members may be employed to provide energy to actuators that are separated from the source, such as those enclosed within a chamber, a structure, or even embedded within a living organism.

As intended herein, conduit 66, which defines the path of the photonic energy from the source 60 to actuator 20 may be a fiber-optic cable or similar device suitable for transporting the energy beam in a non-linear path. The direct-beam embodiment of FIG. 6B may also be implemented using one or more reflectors 70, as shown in FIG. 6C, to alter or direct the energy beam. The embodiment of FIG. 6B is intended to be of a nature that permits the beam to follow the conductor without significant loss of energy so as to prevent or preclude heating of the actuator.

It is further contemplated that, as represented in FIG. 6B, a plurality of actuators may be employed and powered from a single source (e.g., laser). For example, the device may be used to operate a plurality of actuators, say in a toy, where the actuators control various features and operations (perhaps on a larger, macroscopic scale). In the event that multiple actuators are powered, it is contemplated that a splitter, multiplexer or similar switching device 68 may be employed to control the application of energy to the various actuators.

As used herein, the term conduit of fiber is intended to include conventional fibers (core, cladding and jacket) as well as newer fiber types, composites, etc. For example a photonic crystal fiber or photonic band-gap fiber (long fiber with longitudinal defects) may be employed as the conduit by which the energy is transmitted to the point of application. At the point of application, the actuator or an associated device may employ a focusing or concentrating mechanism 80 as illustrated in FIG. 6C, to assure or improve the application of energy at the intended location. It is further contemplated that some combination of energy sources, conduits etc. may be employed to generate and move the energy to the actuator, for example FIG. 6C.

In accordance with the embodiments described herein, SMA actuators, and particularly microactuators, may be produced to provide the “muscles” of tiny robots that are fabricated by MEMS technology on silicon wafers. It will be further appreciated that such structures may be employed for fabricating other nanotechnology devices and elements, and particularly for moving a microscopic x-y stage, RF switches, etc. However, this invention is also applicable to nanotechnology where the nanoactuators are large molecules that are undergoing shape transformations as a result of interactions with focused beam energy such as photons, particle beams (such as electrons), or phonons (ultrasound).

In recapitulation, the present invention is a method and apparatus for the production and operation of microactuators by energy in the nature of a beam, and more particularly to a wireless technique for both control and energy, as well as the return path for observation and data. While the foregoing disclosure sets forth various embodiments, it is evident that many alternatives, modifications, and variations will be apparent to those skilled in the art. Accordingly, the claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method for driving a nano-sized actuator, including the steps of:
pre-straining a nano-sized shape memory alloy in a low-temperature state to produce the actuator; and
subsequently heating, at least a portion of the actuator, above a phase transformation temperature to cause a change in shape of the actuator.

2. The method of claim 1, wherein the change in shape is accomplished by at least a first portion of the actuator moving relative to a second portion of the actuator.

3. The method of claim 1, further including the step of providing a software feedback loop, wherein said feedback loop provides control of the shape memory alloy actuator.

4. The method of claim 1, wherein the heating step employs a photon beam to generate heat.

5. The method of claim 1, wherein the heating step further includes the step of delivering energy to the actuator using a photonic energy conductor.

6. The method of claim 5, wherein the photonic energy conductor is arranged so as to traverse a non-linear path.

7. The method of claim 6, wherein the photonic energy conductor is a flexible fiber-optic cable.

8. The method of claim 4, wherein the step of delivering energy further employs using a single source of photonic energy to for heating a plurality of actuators.

9. An apparatus for driving a shape memory alloy actuator, including:
a shape memory alloy actuator having at least one protrusion extending therefrom;
means for pre-straining shape memory actuator, by displacing the protrusion in a low-temperature state to form a first shape;
means for directing photonic energy at a region of the shape memory actuator and thereby, causing the temperature to rise above a phase transformation temperature, such that the shape of the shape memory actuator is altered from its first shape, said means for directing photonic energy further including a feedback path for sensing movement of the shape memory actuator.

10. The apparatus of claim 9, wherein said feedback path is suitable for verifying the position of the shape memory actuator.

11. The apparatus of claim 10, wherein the feedback path further comprises a sensor that indicates one of at least two positions of the shape memory actuator as a result of optical feedback.

12. The apparatus of claim 10, wherein the feedback path includes a photonic energy directing means, and where the photonic energy directing means includes a non-linear path through which the photonic energy travels.

13. The apparatus of claim 12, wherein the photonic energy directing means further includes:
a photonic energy source; and
a plurality of non-linear paths through which the photonic energy travels from a single source, and where the single source is capable of providing sufficient energy to cause the heating of a plurality of shape memory actuators.

14. The apparatus of claim 13, wherein at least one of said non-linear paths includes a fiber-optic cable.

15. The apparatus of claim 13, wherein at least one of said non-linear paths includes a photonic energy reflector.

16. The apparatus of claim 9, wherein said photonic energy is applied using light in a infrared wavelength, and wherein said shape memory alloy actuator is located within an enclosure.

17. An actuator apparatus, including:
a thermally-activated actuator having at least one protrusion extending therefrom;
means for pre-straining the actuator by displacing the protrusion in a low-temperature state; and
a photonic energy source for applying photonic energy at a region near the protrusion, for heating the actuator and thereby causing the temperature to rise above a phase transformation temperature such that the actuator changes shape, said source comprising a non-linear optical fiber for transfer of the photonic energy from said source to said actuator.

18. The apparatus of claim 17, wherein the non-linear path includes a reflector.

19. The apparatus of claim 17, wherein the optical fiber is a photonic crystal fiber.

20. The apparatus of claim 17, wherein the optical fiber is a photonic band-gap fiber.
